(19) United States
(12) Patent Application Publication
(10) Pub. No.: US 2017/0161591 A1
(43) Pub. Date: Jun. 8, 2017

(54) SYSTEM AND METHOD FOR DEEP-LEARNING BASED OBJECT TRACKING

(71) Applicant: Pilot AI Labs, Inc., Sunnyvale, CA (US)

(72) Inventors: Elliot English, Stanford, CA (US); Ankit Kumar, San Diego, CA (US); Brian Pierce, Santa Clara, CA (US); Jonathan Su, San Jose, CA (US)

(73) Assignee: Pilot AI Labs, Inc., Sunnyvale, CA (US)

(21) Appl. No.: 15/368,505

(22) Filed: Dec. 2, 2016

Related U.S. Application Data
(60) Provisional application No. 62/263,611, filed on Dec. 4, 2015.

(51) Int. Cl. G06K 9/66; G06T 7/70; G06N 3/08

(52) U.S. Cl. CPC G06K 9/66; G06N 3/08; G06T 7/70

(57) ABSTRACT

According to various embodiments, a method for deep-learning based object tracking by a neural network is provided. The method comprises a training mode and an inference mode. In the training mode, the method includes: passing a dataset into the neural network, the dataset including a first image frame and a second image frame; and training the neural network to accurately output a similarity measure for the first and second image frames. In the inference mode, the method includes: passing a plurality of image frames into the neural network, wherein the plurality of image frames is not part of the dataset, the plurality of image frames comprising a first image frame and a second image frame, the first image frame including a first bounding box around an object and the second image frame including a second bounding box around an object; and automatically determining whether the object bounded by the first bounding box is the same object as the object bounded by the second bounding box.

### CROSS REFERENCE TO RELATED APPLICATIONS

The application claims priority under 35 U.S.C. §119(e) to U.S. Provisional Application No. 62/263,611, filed Dec. 4, 2015, entitled SYSTEM AND METHOD FOR DEEP-LEARNING BASED OBJECT TRACKING, the contents of which are hereby incorporated by reference.

### TECHNICAL FIELD

The present disclosure relates generally to machine learning algorithms, and more specifically to object tracking using machine learning algorithms.

### BACKGROUND

Systems have attempted to use various neural networks and computer learning algorithms to track objects. However, existing attempts to track objects are not successful because the methods of pattern recognition and estimating location of objects are inaccurate and non-general. Furthermore, existing systems attempt to track objects by some sort of pattern recognition that is too specific, or not sufficiently adaptable. Thus, there is a need for an enhanced method for training a neural network to detect and track an object through a series of frames with increased accuracy by utilizing improved computational operations.

### SUMMARY

The following presents a simplified summary of the disclosure in order to provide a basic understanding of certain embodiments of the present disclosure. This summary is not an extensive overview of the disclosure and it does not identify key/critical elements of the present disclosure or delineate the scope of the present disclosure. Its sole purpose is to present some concepts disclosed herein in a simplified form as a prelude to the more detailed description that is presented later.

In general, certain embodiments of the present disclosure provide techniques or mechanisms for improved object detection by a neural network. According to various embodiments, a method for deep-learning based object tracking by a neural network is provided. The method comprises a training mode and an inference mode. In the training mode, the method includes: passing a dataset into the neural network, the dataset including a first image frame and a second image frame; and training the neural network to accurately output a similarity measure for the first and second image frames. In the inference mode, the method includes: passing a plurality of image frames into the neural network, wherein the plurality of image frames is not part of the dataset, the plurality of image frames comprising a first image frame and a second image frame, the first image frame including a first bounding box around an object and the second image frame including a second bounding box around an object; and automatically determining whether the object bounded by the first bounding box is the same object as the object bounded by the second bounding box.

In another embodiment, a system deep-learning based object tracking by a neural network is provided. The system includes one or more processors, memory, and one or more programs stored in the memory. The one or more programs comprise instructions to operate in a training mode and an inference mode. In the training mode, the one or more programs comprise instructions to: pass a dataset into the neural network, the dataset including a first image frame and a second image frame; and train the neural network to accurately output a similarity measure for the first and second image frames. In the inference mode, the one or more programs comprise instructions to: pass a plurality of image frames into the neural network, wherein the plurality of image frames is not part of the dataset, the plurality of image frames comprising a first frame and a second frame, the first image frame including a first bounding box around an object and the second image frame including a second bounding box around an image; and automatically determine that the object bounded by the first bounding box is the same object as the object bounded by the second bounding box.

In yet another embodiment, a non-transitory computer readable medium is provided. The computer readable medium storing one or more programs comprise instructions to operate in a training mode and an inference mode. In the training mode, the one or more programs comprise instructions to: pass a dataset into the neural network, the dataset including a first image frame and a second image frame; and train the neural network to accurately output a similarity measure for the first and second image frames. In the inference mode, the one or more programs comprise instructions to: pass a plurality of image frames into the neural network, wherein the plurality of image frames is not part of the dataset, the plurality of image frames comprising a first frame and a second frame, the first image frame including a first bounding box around an object and the second image frame including a second bounding box around an image; and automatically determine that the object bounded by the first bounding box is the same object as the object bounded by the second bounding box.

### BRIEF DESCRIPTION OF THE DRAWINGS

The disclosure may best be understood by reference to the following description taken in conjunction with the accompanying drawings, which illustrate particular embodiments of the present disclosure.

FIG. 1 illustrates a particular example of tracking objects through a series of frames, in accordance with one or more embodiments.

FIG. 2 illustrates an example of computational layers in a neural network, in accordance with one or more embodiments.

FIG. 3A-3C illustrate one example of a method for deep-learning based object tracking by a neural network, in accordance with one or more embodiments.

FIGS. 4A-4C illustrate another example of a method for deep-learning based object tracking by a neural network, in accordance with one or more embodiments.

FIG. 5 illustrates one example of a neural network system that can be used in conjunction with the techniques and mechanisms of the present disclosure in accordance with one or more embodiments.

### DETAILED DESCRIPTION OF PARTICULAR EMBODIMENTS

Reference will now be made in detail to some specific examples of the present disclosure including the best modes contemplated by the inventors for carrying out the present disclosure. Examples of these specific embodiments are illustrated in the accompanying drawings. While the present disclosure is described in conjunction with these specific embodiments, it will be understood that it is not intended to limit the present disclosure to the described embodiments. On the contrary, it is intended to cover alternatives, modifications, and equivalents as may be included within the spirit and scope of the present disclosure as defined by the appended claims.

For example, the techniques of the present disclosure will be described in the context of particular algorithms. However, it should be noted that the techniques of the present disclosure apply to various other algorithms. In the following description, numerous specific details are set forth in order to provide a thorough understanding of the present disclosure. Particular example embodiments of the present disclosure may be implemented without some or all of these specific details. In other instances, well known process operations have not been described in detail in order not to unnecessarily obscure the present disclosure.

Various techniques and mechanisms of the present disclosure will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors while remaining within the scope of the present disclosure unless otherwise noted. Furthermore, the techniques and mechanisms of the present disclosure will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

Overview

In general, certain embodiments of the present disclosure provide techniques or mechanisms for improved object detection by a neural network. According to various embodiments, a method for deep-learning based object tracking by a neural network is provided. The method comprises a training mode and an inference mode. In the training mode, the method includes: passing a dataset into the neural network, the dataset including a first image frame and a second image frame; and training the neural network to accurately output a similarity measure for the first and second image frames. In the inference mode, the method includes: passing a plurality of image frames into the neural network, wherein the plurality of image frames is not part of the dataset, the plurality of image frames comprising a first image frame and a second image frame, the first image frame including a first bounding box around an object and the second image frame including a second bounding box around an object; and automatically determining whether the object bounded by the first bounding box is the same object as the object bounded by the second bounding box.

### Example Embodiments

In various embodiments, the system for object tracking uses deep-learning to track objects from a video stream. More specifically, this system takes as input, a sequence of frames (the frames should be continuous, from a video feed) as well as minimal bounding boxes for all the objects of interest within each image. The bounding boxes around the objects are not given in any meaningful order. The bounding boxes in the system come from a neural network system for object detection. Each bounding box is specified by its center location, height, and width (all in pixel coordinates). The problem of tracking is to be able to match boxes from one frame to the next. For example, suppose there is one frame which is has two boxes (for two instances of a certain object, e.g. a person's head). Suppose that the first box belongs to person #1, and the second box belongs to person #2. Suppose there is a second frame which has two boxes (which are not necessarily in the same order as the boxes from the previous frame). The tracking algorithm should be able to determine whether or not the boxes in the second frame belong to the same people as the boxes in the previous frame, and also specifically which box belongs to which person.

In various embodiments, certain cases of this problem are relatively trivial. For example, of one person is always in the top, left corner of the image, and the second person is always in the bottom right corner of the image, then it is obvious that the box that is in the top left of the image always belongs to the first person, and the box in the bottom, right of the image belongs to the second person. However, there are many cases that are not trivial which the algorithm is able to handle. For example, a person might hide behind another person for some number of frames, and then reappear. The algorithm should be able to determine that the box associated with the “hidden” person is not given for a certain number of frames, and then that it reappears later.

The algorithm accomplishes this task by computing a tensor representation of the object contained within the box that is able to be compared to other tensor representations of the same type of object and determine whether or not the other tensor representations are in fact the same instance of that object (e.g. the same person), or a different instance of the object (e.g. a different person).

Training Procedure

The precise details of how one example algorithm computes the tensor representation are given below. At a high level, a neural network outputs the tensor representation. That neural network is trained using a dataset which contains many (image, unique-identifier) pairs. For example, the dataset for tracking people's heads contains many images of people's heads. There are multiple different images for each individual person. Each image is labeled with a unique identifier (e.g. for people, it's a unique name). During training, two images from the dataset are fed into the neural network, the tensor representation for both images are then computed, and the two tensor representations are compared. The parameters of the neural network are then trained such that the tensor representations are similar for two different images of the same instance of an object (e.g. same person), but also such that the tensor representations are different for two images from two different instances of the same object (e.g. two different people).

Description of the Neural Network for the Tracking Algorithm

In various embodiments, the neural network begins with a “convolution nonlinearity” step. As in patent #1, the input to the “convolution nonlinearity” step are pixels from an image. However, these pixels are only the pixels within the bounding box. Thus, given a larger image and a list of bounding boxes for different instances of the object(s) of interest, the larger image is cropped to a smaller image for each of the bounding boxes. The smaller images are then all resized to a constant size of 100×100 pixels. This size was chosen because it is a small enough image for the computation to run in real-time, but enough pixels to contain a meaningful image of the instance of the object of interest. Each of the smaller images is fed one at a time into the “convolution nonlinearity” step. The output of the “convolution nonlinearity” step is taken as the tensor representation of that particular instance of the object.

In some embodiments, two tensor representations are compared to determine whether or not they are the same instance of an object or different instances (e.g. different people). One example mathematical comparison function is as follows: given two first-order tensors [symbol] x̂((1)) [symbol] _i and [symbol] x̂((2)) [symbol] _i, a similarity score is computed between the two tensors as:

s= [symbol] σ(Σ) [symbol] _i [symbol] x̂((1)) [symbol] _i [symbol] x̂((2)) [symbol] _i),

where σ(x)=1/(1+ê(−x)) is the sigmoid function. What this function does is: 1) compute the distance between the two first-order tensors (first order tensors are just vectors, so this is simple the distance between two vectors), and then 2) rescale that distance to be a number between 0 and 1 (that is all the sigmoid function does—it takes a number between −infinity and infinity and rescales it to between 0 and 1). The result is a normalized score objectively indicating how “close” the two input tensors are.

It is important to note that the cropped, 100×100 input image is itself a tensor which could be cast as a first-order tensor, and it would be mathematically possible to simply compare the input images without using a “convolution nonlinearity” step. The reason the “convolution nonlinearity” step is included is that the step contains parameters which the neural network can learn (through the training procedure), and the result is that the output tensor from the “convolution nonlinearity” step is much better at distinguishing between whether or not two different images are the same instance of a certain type of object, or different instances of a certain type of object (it's much better than just using the original pixels).

Inference Procedure

The training procedure was described above. However, the exact algorithm for inference has not been fully described. At inference, a sequence of frames is given, and for each frame, a set of minimal bounding boxes is given for some number of objects. Each bounding box corresponds to a unique instance of the object(s) of interest (this means that one cannot have 2 boxes around the same instance of the same object). The task at inference is to match the current frame/set-of-boxes at time t, to the previous frame/set-of-boxes-and-unique-identities (with the possibility that there are some boxes in the current frame which have new identities and were not in the previous frame). The procedure for doing this matching is as follows:

In various embodiments, tensor representations are first computed for all the boxes between both the current frame (denoted as index t) and the previous frame (denoted as index t−1). In some embodiments, matching for the previous frame has already occurred, as well as the frame two frames ago. Thus, in some embodiments the tensor representations of all the boxes in the previous frame have already been computed/stored, and thus the system only needs to compute the tensor representations for all the boxes in the current frame.

In various embodiments, the system next computes similarity scores between all the representations in the previous frame and all the representations in the current frame. Any similarity scores that are less than 0.5 are deemed not to be a match (meaning that they belong to a new instance of the object(s) being tracked). The similarity scores which are greater than 0.5 are determined to be a match. If two boxes from the current frame have a similarity score greater than 0.5 when compared to a single box from the previous frame, the box pair with the greater similarity score is taken to be the match, and the other box is available to be matched to some other box in the previous frame.

In some embodiments, the final result of the above “matching” procedure is that for a sequence of frames, unique instances of a certain type of objects (or multiple types of objects as well) are tracked.

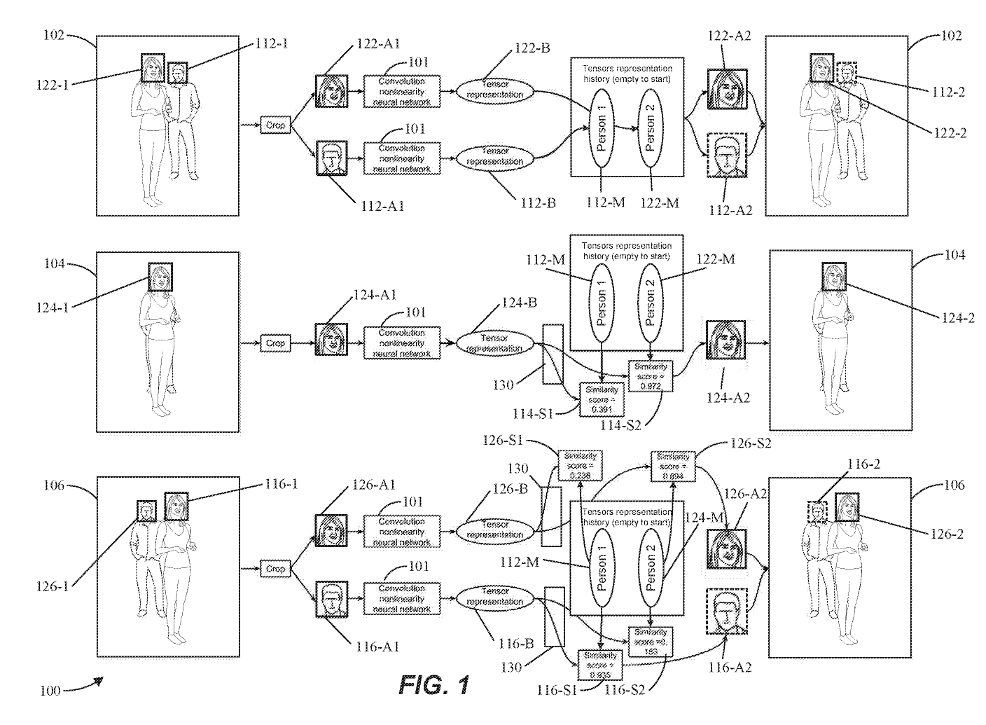

FIG. 1 illustrates how the tracking system 100 works for a sequence of frames. FIG. 1 begins with the input frame 102 which has been run through the neural network detection system described in the U.S. patent application titled SYSTEM AND METHOD FOR IMPROVED GENERAL OBJECT DETECTION USING NEURAL NETWORKS filed on Nov. 30, 2016 which claims priority to U.S. Provisional Application No. 62/261,260, filed Nov. 30, 2015, of the same title filed on Nov. 30, 2015, each of which are hereby incorporated by reference. The neural network system of such incorporated patent applications is trained to detect objects of interest, such as faces of individuals. Once trained, such neural network detection system may accurately output a box around one or more objects of interests, such as faces of individuals. The outputted box may include a box size corresponding to the smallest possible bounding box around the pixels corresponding to the object of interest. The outputted box may also include a center location of the object of interest.

As such, frame 102 includes bounding boxes 122-1 and 112-1 known for each of the objects of interest. Bounding boxes 122-1 and 112-1 each bound the face of an individual person in image frame 102 For purposes of illustration, boxes 122-1 and 112-1 may not be drawn to scale. Thus, although boxes 122-1 and 112-1 may represent smallest possible bounding boxes, for practical illustrative purposes, they are not literally depicted as such in FIG. 1. In some embodiments, the borders of the bounding boxes are only a single pixel in thickness and are only thickened and enhanced, as with boxes 122-1 and 112-1, when the bounding boxes have to be rendered in a display to a user, as shown in FIG. 1.

The bounding boxes 122-1 and 112-1 are unordered from one frame to the next, so there may be no information given about which instance of an object is contained within which bounding box. Given the coordinates of the bounding boxes, the original image is cropped to extract the pixels from within the regions spanned by each bounding box 112-1 and 122-1. Applying this crop to bounding box 122-1 yields image 122-A1. Applying this crop to bounding box 112-1 yields image 112-A1. Both cropped images 112-A1 and 122-A1 are then run through a convolution nonlinearity neural network 101, described herein, to produce tensor representations. In some embodiments, the cropped images 112-A1 and 122-A1 may be run through the convolution nonlinearity neural network 101 separately. Image 112-A1 yields the tensor representation 112-B, which is then stored in memory 112-M as being associated with “person 1.” Image 122-A1 yields the tensor representation 122-B which is then stored in memory 122-M as being associated with “person 2.” In some embodiments, the different identities may be represented by outputting different colored boxes around each unique object of interest. However, as shown in FIG. 1, a box with dashed lines 112-A2 is assigned to person 1, and a box with solid lines 122-A2 is assigned to person 2. The box with dashed lines 112-A2 may correspond to a blue box, while the box with solid lines 122-A2 may correspond to a red box. In various embodiments, the original image 102 may be redrawn with the new colored bounding boxes indicating that the two objects have unique identities. Redrawing the original bounding box 112-1 yields the new, blue bounding box 112-2, represented by dashed lines. Redrawing the original bounding box 122-1 yields the new, red bounding box 122-2, represented by solid lines.

The next image frame 104 in the sequence is then input into system 100. Image 104 only has one person visible, which has a bounding box 124-1, output from the neural network detection system previously described. The crop for the bounding box 124-1 is applied to the image 104 to yield the cropped image 124-A1. Cropped image 124-A1 is used as input to the convolution nonlinearity neural network 101 to produce the tensor representation 124-B. This tensor representation is now compared to the previous tensor representations associated with each person stored in memory (112-M and 122-M). Such comparison may be performed by similarity module 130 within system 100. Comparing the tensor representation 124-B for this frame with the tensor representation 112-M for person 1 yields the similarity score 114-S1 which has a value of 0.391. Comparing the tensor representation 124-B for this frame with the tensor representation 122-M for person 2 yields the similarity score 114-S2 which has a value of 0.972. As used herein, the terms “similarity score,” “similarity value,” and “similarity measure” may be used interchangeably. Because similarity score 114-S2 is greater than similarity score 114-S1, the system concludes that the object contained within the cropped image 124-A1 corresponds to person 2. The tensor representation 122-M for person 2 is then updated to be tensor representation 124-B, which store in memory as tensor 124-M. In some embodiments, the updated tensor representation 124-B may include a combination of all tensor representations 122-B and 124-B corresponding to person 2. System 100 chooses the color associated with person 2 (red) to produce the boxed object image 124-A2, which is represented by solid lines. This can then be rendered in the context of the full image 104, yielding the bounding box 124-2.

The third image frame 106 in the sequence is then processed. Image 106 contains two bounding boxes 116-1 and 126-2, which are output from the neural network detection system previously described. The cropping procedure is applied to these bounding boxes to yield object images 116-A1 and 126-A2, respectively. Cropped images 116-A1 and 126-A2 are used as the as input to the convolution nonlinearity neural network 101 to produce tensor representations 116-B and 126-B, respectively.

The similarity score 116-S1 is computed between tensor 116-B and tensor 112-M for person 1 by similarity module 130, which yields a value 0.935. The similarity score 116-S2 is computed between tensor 116-B and tensor 124-M for person 2 by similarity module 130, which yields a value 0.183. The similarity score 126-S1 is computed between tensor 126-B and tensor 112-M for person 1 by similarity module 130, which yields the value 0.238. The similarity score 126-S2 is computed between tensor 126-B and tensor 124-M for person 2 by similarity module 130, which yields a score 0.894. The similarity scores 116-S1, 116-S2, 126-S1, and 126-S2, are analyzed to find the matching which will maximize the total score. The matching that yields the maximum score is to take tensor 116-B as corresponding to person 1 (giving the blue-box cropped image 116-A2, represented by dashed lines) and tensor 126-B as corresponding to person 2 (giving the red-box cropped image 126-A2, represented by solid lines). Rendering the blue box 116-A2 in the original image 106 yields the box 116-2, represented by dashed lines. Rendering the red box 126-A2 in the original image 106 yields the box 126-2, represented by solid lines. The tensor representation for person 2 is then updated to be tensor representation 126-B, which store in memory as tensor 126-M (not shown). In some embodiments, the tensor representation 126-M may include a combination of all tensor representations 122-B, 124-B, and 126-B, corresponding to person 2. Similarly, the tensor representation for person 1 is then updated to be tensor representation 116-B, which store in memory as tensor 116-M (not shown). In some embodiments, the tensor representation 116-M may include a combination of all tensor representations 112-B and 116-B, corresponding to person 1.

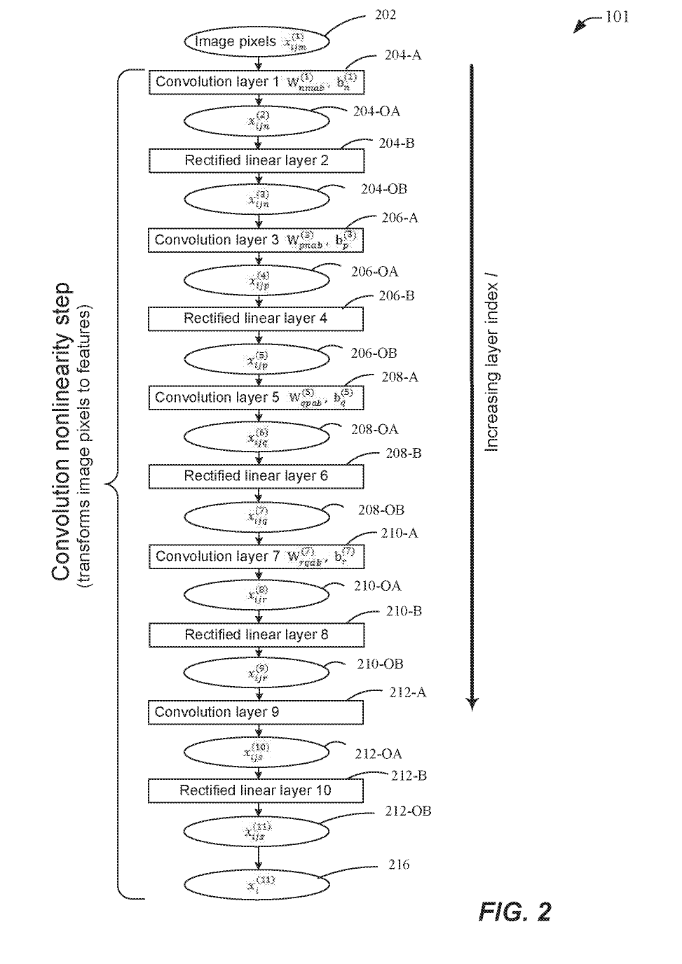

FIG. 2 illustrates the pipeline for producing tensor representations using the convolution nonlinearity neural network 101, as described with reference to FIG. 1. Neural network 101 may comprise a convolution-nonlinearity step with one or more convolution-nonlinearity layer pairs, such as 204, 206, 208, 210, and 212. Each convolution-nonlinearity layer pair may include a convolution layer followed by a rectified linear layer. An input image tensor 202 is input into the system, and specifically input into the first convolution layer 204-A. Convolution layer 204-A produces output tensor 204-OA. Tensor 204-OA is used as input for rectified linear layer 204-B, which yields the output tensor 204-OB. Tensor 204-OB is used as input for convolution layer 206-A, which produces output tensor 206-OA. Tensor 206-OA is used as input for rectified linear layer 206-B, which yields the output tensor 206-OB. Tensor 206-OB is used as input for convolution layer 208-A, which produces output tensor 208-OA. Tensor 208-OA is used as input for rectified linear layer 208-B, which yields the output tensor 208-OB. Tensor 208-OB is used as input for convolution layer 210-A, which produces output tensor 210-OA. Tensor 210-OA is used as input for rectified linear layer 210-B, which yields the output tensor 210-OB. Tensor 210-OB is used as input for convolution layer 212-A, which produces output tensor 212-OA. Tensor 212-OA is used as input for rectified linear layer 212-B, which yields the output tensor 212-OB. Tensor 212-OB is transformed from a third order tensor to a first order tensor 216, which is the final feature tensor produced by the convolution nonlinearity neural network 200.

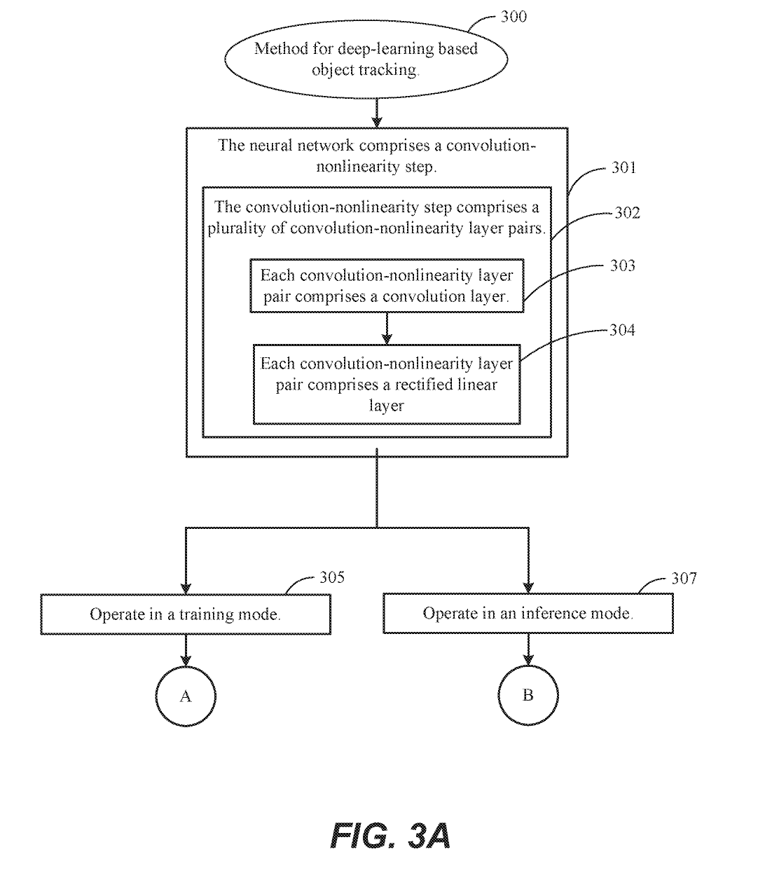

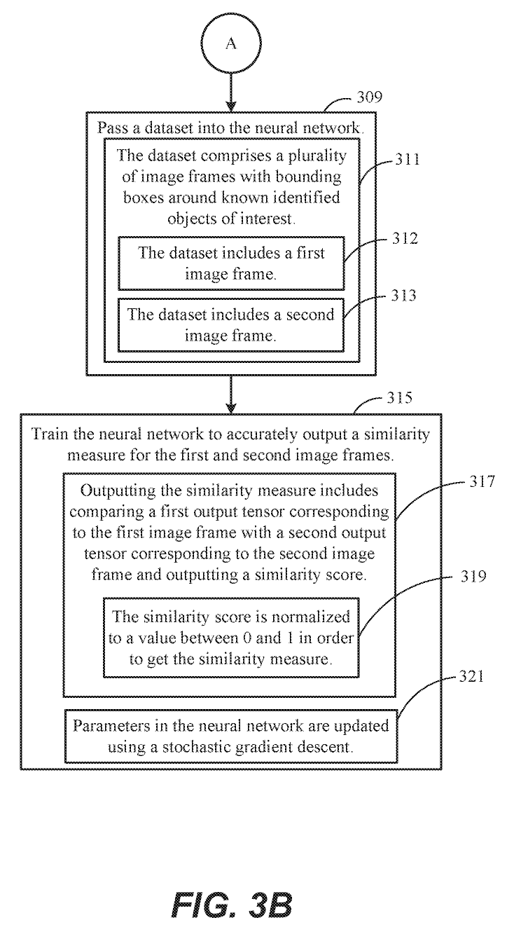

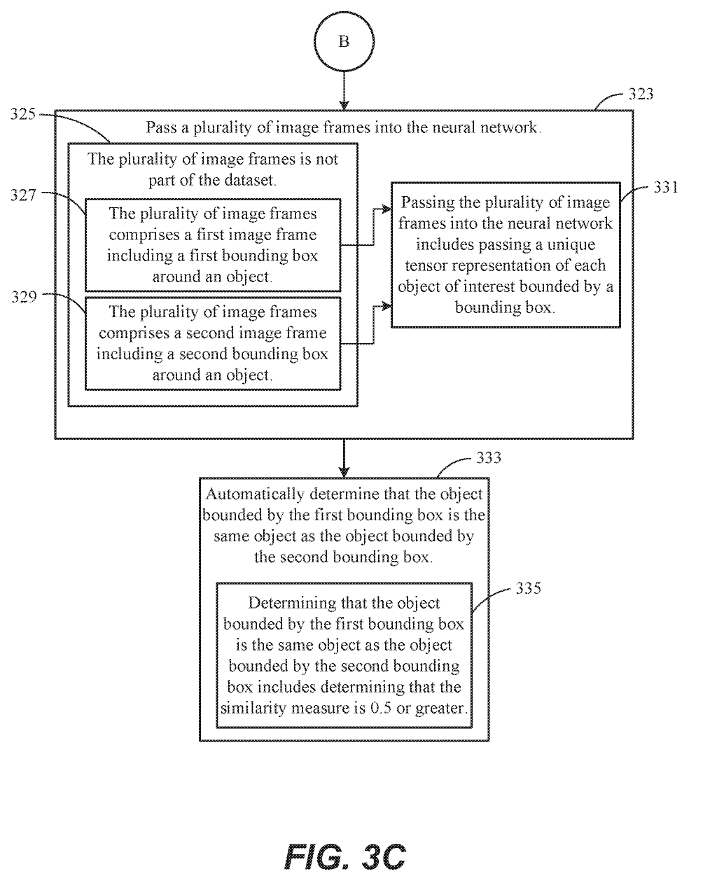

FIG. 3A illustrates an example of a method 300 for deep learning based object tracking by a neural network 301, in accordance with one or more embodiments. In certain embodiments, the neural network 301 may be neural network 101 within a tracking system, such as tracking system 100. Neural network 301 may comprise a convolution-nonlinearity step 301. In some embodiments convolution-nonlinearity step 301 may be the convolution-nonlinearity step in neural network 101, described with reference to FIG. 2, with the same or similar computational layers. In other embodiments, neural network 301 may comprise multiple convolution-nonlinearity steps. In some embodiments, each convolution-nonlinearity step comprises a plurality of convolution-nonlinearity layer pairs 302. In some embodiments, neural network 301 may include only one convolution-nonlinearity layer pair 302. In some embodiments, each convolution-nonlinearity layer pair 302 may comprise a convolution-nonlinearity layer 303 followed by a rectified linear layer 304. Method 300 may operate in a training mode 305 and an inference mode 307.

FIG. 3B illustrates an example of operations of a neural network 301 in training mode 305, in accordance with one or more embodiments. When operating in the training mode 305, a dataset is passed into the neural network 301 at 309. In some embodiments, the dataset may comprise a plurality of image frames with bounding boxes 311 around known identified objects of interest, including a first image frame 312 and a second image frame 313. In some embodiments, passing the dataset into the neural network 301 may comprise inputting the pixels of each image, such as that of image 102, in the dataset as third-order tensors into a plurality of computational layers, such as those in convolution-nonlinearity step of neural network 301 described above and/or neural network 101 in FIG. 2.

In some embodiments, the image pixels input into neural network 301 at step 309 may comprise a portion of the image in an image frame in the dataset, such as 312 and 313, which may be captured by a camera. For example, the portion of the image frame may be defined by a bounding box 311. In some embodiments, inputting the pixels of each image into neural network 301 includes selecting and cropping pixels within one or more bounding boxes 311 output by a neural network detection system as described in the U.S. patent application entitled SYSTEM AND METHOD FOR IMPROVED GENERAL OBJECT DETECTION USING NEURAL NETWORKS, referenced above. In other embodiments, the one or more bounding boxes 311 within each image frame of the dataset is predetermined and manually marked to correctly border a desired object of interest. The pixels within a bounded box 311 may then be input into neural network 301. In various embodiments, pixels within multiple bounding boxes 311 of an image frame may be input into neural network 301 separately or simultaneously. According to various examples, a bounding box 311 in a first image frame 312 and a bounding box 311 in a second image frame 312 may correspond to the same object of interest.

At 315, neural network 301 is trained to accurately output output tensors corresponding to the input pixels to be utilized by a tracking system to determine a similarity measure 317 (or similarity value) for the input pixels of the first image frame 312 and the input pixels for the second image frame 313, such as previously described with reference to FIG. 1. In some embodiments, outputting the similarity measure 317 includes comparing a first output tensor corresponding to image pixels within a bounding box 311 in the first image frame with a second output tensor corresponding to image pixels within a bounding box 311 in the second image frame and outputting a similarity score 319. In various embodiments, a similarity module, such as similarity module 130, compares the first and second output tensors to determine the similarity score 319. In some embodiments, the similarity score 319 is normalized to a value between 0 and 1 in order to get the similarity measure 317.

During the training mode 305 in certain embodiments, parameters in the neural network may be updated using a stochastic gradient descent 321. In some embodiments, neural network 301 is trained until neural network 301 outputs output tensors that can be used by a tracking system 100 to compute accurate similarity measures for the same object bounded by bounding boxes 311 between two image frames at a predefined threshold accuracy rate. In various embodiments, the specific value of the predefined threshold may vary and may be dependent on various applications.

Once neural network 301 is deemed to be sufficiently trained, neural network 301 may be used to operate in the inference mode 307. FIG. 3C illustrates an example of operations of a neural network 301 in inference mode 307, in accordance with one or more embodiments. When operating in the inference mode 307, a plurality of image frames are passed into the neural network 301 at 323. In some embodiments, the plurality of image frames is not part of the dataset from step 309. In some embodiments, the plurality of image frames 325 comprises a first image frame including a first bounding box 327 around an object. The plurality of image frames 325 further comprises a second image frame including a second bounding box 329 around an object. As previously described, first bounding box 327 and second bounding box 329 may be output by a neural network detection system as described in the U.S. patent application entitled SYSTEM AND METHOD FOR IMPROVED GENERAL OBJECT DETECTION USING NEURAL NETWORKS, referenced above. As also previously described, first bounding box 327 and second bounding box 329 may be set around the same object or different objects.

In some embodiments, passing the plurality of image frames 325 into neural network 301 at step 323 includes passing only a portion of the image frames 325 into the neural network 301. For example, image frames 325 may be captured by a camera, and a portion of an image frame may be defined by a bounding box, such as 327 and/or 329. The pixels within a bounding box may then be selected and cropped. The cropped image may then be input into neural network 301. In various embodiments, pixels within multiple bounding boxes of an image frame may be input into neural network 301 separately or simultaneously. According to various examples, a first bounding box 327 in the first image frame and a second bounding box 329 in a second image frame may correspond to the same object of interest.

In some embodiments, passing the plurality of image frames into the neural network 301 includes passing a unique tensor representation 331 of each object of interest bounded by a bounding box. In some embodiments, the tensor representation 331 corresponds to the pixels bounded within the bounding box, such as 327 and/or 329.

At 333, a tracking system, such as tracking system 100, automatically determines that the object bounded by the first bounding box 327 is the same object as the object bounded by the second bounding box 329. As previously described, such determination at step 333 may be performed by similarity module, such as similarity module 130. In some embodiments, determining that the object bounded by the first bounding box 327 is the same object as the object bounded by the second bounding box 329 includes determining that the similarity measure 335 is 0.5 or greater. Thus, a tracking system, such as tracking system 100, may determine whether an object in the first image frame is the same object in the second image frame. The tracking system may accomplish this even when the object is located at different locations in each image frame, or where different viewpoints or changes to the object are depicted in each image frame. This allows identification and tracking of one or more objects over a given image sequence and/or video comprising multiple image frames.

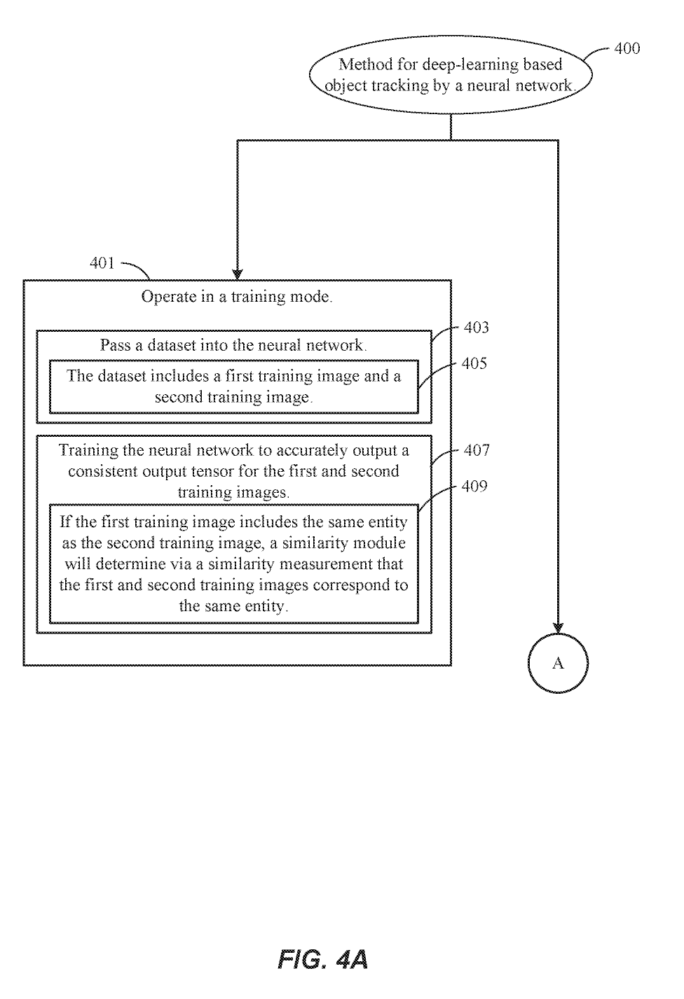

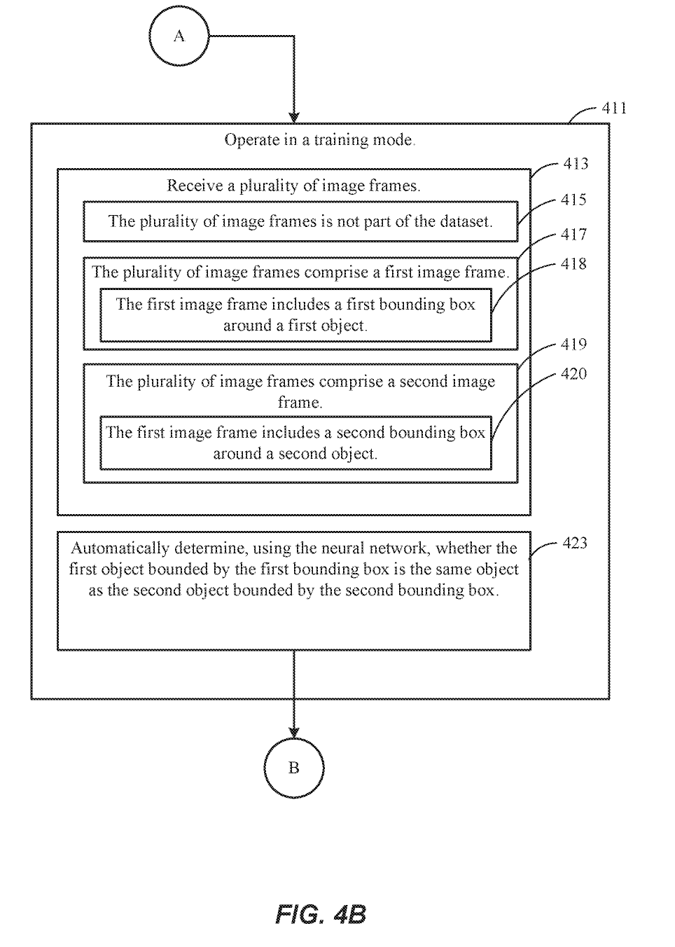

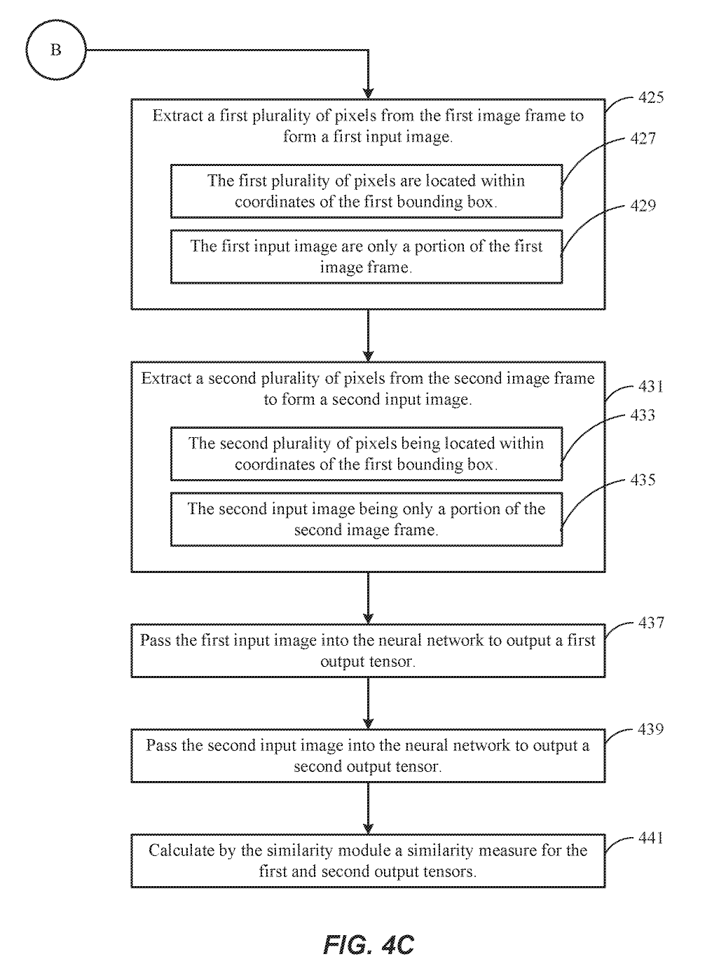

With reference to FIGS. 4A, 4B, and 4C, shown is another example of a method 400 for deep-learning based object tracking by a neural network, in accordance with one or more embodiments. Like method 300, method 400 may operation in a training mode 401 and an inference mode 411. FIG. 4A includes an example of the operations in training mode 401, in accordance with one or more embodiments. In the training mode 401, a dataset 405 is passed into the neural network at operation 403. In some embodiments, the dataset 405 includes a first training image and a second training image. At operation 407, in training mode 401, the neural network is trained to accurately output a consistent output tensor for the first and second training images. If the first training image includes the same entity as the second training image, a similarity module 409 will determine via a similarity measurement that the first and second training images correspond to the same entity. In some embodiments, similarity module 409 may be similarity module 130.

FIGS. 4B and 4C illustrate an example of the operations in inference mode 411, in accordance with one or more embodiments. At operation 413, a plurality of image frames 415 is received. In some embodiments, the plurality of image frames 413 is not part of the dataset 405. The plurality of image frames 415 comprise a first image frame 417. The first image frame 417 includes a first bounding box 418 around a first object. The plurality of image frames 415 also comprise a second image frame 419. The second image frame 419 includes a second bounding box 420 around a second object.

At operation 423, It is automatically determined, using the neural network whether the first object bounded by the first bounding box 418 is the same object as the second object bounded by the second bounding box 420. In various embodiments, operation 423 may include extracting a first plurality of pixels 427 from the first image frame 417 to form a first input image 429 at step 425. The first plurality of pixels 427 may be located within coordinates of the first bounding box 418. The first input image 429 may be only a portion of the first image frame 417.

Operation 423 may further include extracting a second plurality of pixels 433 from the second image frame 419 to form a second input image 435 at step 431. The second plurality of pixels 433 may be located within coordinates of the second bounding box 420. The second input image 435 may be only a portion of the second image frame 419.

Operation 423 may further include passing the first input image 429 may then be passed into the neural network to output a first output tensor at step 437. The second input image 435 may then be passed into the neural network to output a second output tensor at step 439. Then at step 441, a similarity measure for the first and second output tensors is calculated by the similarity module 409.

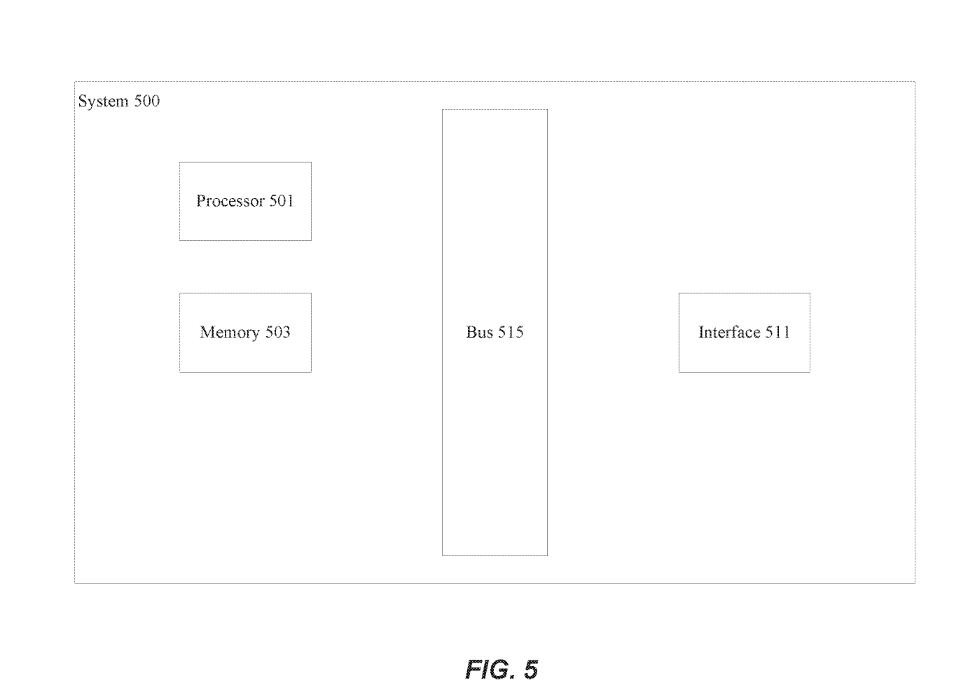

FIG. 5 illustrates one example of a neural network system 500, in accordance with one or more embodiments. According to particular embodiments, a system 500, suitable for implementing particular embodiments of the present disclosure, includes a processor 501, a memory 503, an interface 511, and a bus 515 (e.g., a PCI bus or other interconnection fabric) and operates as a streaming server. In some embodiments, when acting under the control of appropriate software or firmware, the processor 501 is responsible for various processes, including processing inputs through various computational layers and algorithms. Various specially configured devices can also be used in place of a processor 501 or in addition to processor 501. The interface 511 is typically configured to send and receive data packets or data segments over a network.

Particular examples of interfaces supports include Ethernet interfaces, frame relay interfaces, cable interfaces, DSL interfaces, token ring interfaces, and the like. In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control such communications intensive tasks as packet switching, media control and management.

According to particular example embodiments, the system 500 uses memory 503 to store data and program instructions for operations including training a neural network, object detection by a neural network, and distance and velocity estimation. The program instructions may control the operation of an operating system and/or one or more applications, for example. The memory or memories may also be configured to store received metadata and batch requested metadata.

Because such information and program instructions may be employed to implement the systems/methods described herein, the present disclosure relates to tangible, or non-transitory, machine readable media that include program instructions, state information, etc. for performing various operations described herein. Examples of machine-readable media include hard disks, floppy disks, magnetic tape, optical media such as CD-ROM disks and DVDs; magneto-optical media such as optical disks, and hardware devices that are specially configured to store and perform program instructions, such as read-only memory devices (ROM) and programmable read-only memory devices (PROMs). Examples of program instructions include both machine code, such as produced by a compiler, and files containing higher level code that may be executed by the computer using an interpreter.

While the present disclosure has been particularly shown and described with reference to specific embodiments thereof, it will be understood by those skilled in the art that changes in the form and details of the disclosed embodiments may be made without departing from the spirit or scope of the present disclosure. It is therefore intended that the present disclosure be interpreted to include all variations and equivalents that fall within the true spirit and scope of the present disclosure. Although many of the components and processes are described above in the singular for convenience, it will be appreciated by one of skill in the art that multiple components and repeated processes can also be used to practice the techniques of the present disclosure.

What is claimed is:

1. A method for deep-learning based object tracking by a neural network, the method comprising:
in a training mode:
passing a dataset into the neural network, the dataset including a first
training image and a second training image; and
training the neural network to accurately output a consistent output tensor for the first and second training images, wherein if the first training image includes the same entity as the second training image, a similarity module will determine via a similarity measurement that the first and second training images correspond to the same entity; and
in an inference mode:
receiving a plurality of image frames, wherein the plurality of image frames is not part of the dataset, the plurality of image frames comprising a first image frame and a second image frame, the first image frame including a first bounding box around a first object and the second image frame including a second bounding box around a second object; and
automatically determining, using the neural network, whether the first object bounded by the first bounding box is the same object as the second object bounded by the second bounding box.

2. The method of claim 1, wherein the neural network comprises a convolution-nonlinearity step.

3. The method of claim 2, wherein the convolution-nonlinearity step comprises a convolution layer and a rectified linear layer.

4. The method of claim 1, wherein determining whether the first object bounded by the first bounding box is the same object as the second object bounded by the second bounding box comprises:
extracting a first plurality of pixels from the first image frame to form a first input image, the first plurality of pixels being located within coordinates of the first bounding box, the first input image being only a portion of the first image frame;
extracting a second plurality of pixels from the second image frame to form a second input image, the second plurality of pixels being located within coordinates of the second bounding box, the second input image being only a portion of the second image frame;
passing the first input image into the neural network to output a first output tensor;
passing the second input image into the neural network to output a second output tensor; and
calculating by the similarity module a similarity measure for the first and second output tensors.

5. The method of claim 4, wherein the similarity measure is normalized to a value between 0 and 1.

6. The method of claim 5, wherein determining that the object bounded by the first bounding box is the same object as the object bounded by the second bounding box includes determining that the similarity measure is 0.5 or greater.

7. The method of claim 1, wherein, during the training mode, parameters in the neural network are updated using a stochastic gradient descent.

8. A system for deep-learning based object tracking by a neural network, comprising:
one or more processors;
memory; and
one or more programs stored in the memory, the one or more programs comprising instructions to operate in a training mode and an inference mode;
wherein in the training mode, the one or more programs comprise instructions for:
passing a dataset into the neural network, the dataset including a first training image and a second training image; and
training the neural network to accurately output a consistent output tensor for the first and second training images, wherein if the first training image includes the same entity as the second training image, a similarity module will determine via a similarity measurement that the first and second training images correspond to the same entity; and
wherein in the inference mode, the one or more programs comprise instructions for:
receiving a plurality of image frames, wherein the plurality of image frames is not part of the dataset, the plurality of image frames comprising a first image frame and a second image frame, the first image frame including a first bounding box around a first object and the second image frame including a second bounding box around a second object; and
automatically determining, using the neural network, whether the first object bounded by the first bounding box is the same object as the second object bounded by the second bounding box.

9. The system of claim 8, wherein the neural network comprises a convolution-nonlinearity step.

10. The system of claim 9, wherein the convolution-nonlinearity step comprises a convolution layer and a rectified linear layer.

11. The system of claim 8, wherein determining whether the first object bounded by the first bounding box is the same object as the second object bounded by the second bounding box comprises:
extracting a first plurality of pixels from the first image frame to form a first input image, the first plurality of pixels being located within coordinates of the first bounding box, the first input image being only a portion of the first image frame;
extracting a second plurality of pixels from the second image frame to form a second input image, the second plurality of pixels being located within coordinates of the second bounding box, the second input image being only a portion of the second image frame;
passing the first input image into the neural network to output a first output tensor;
passing the second input image into the neural network to output a second output tensor; and
calculating by the similarity module a similarity measure for the first and second output tensors.

12. The system of claim 11, wherein the similarity measure is normalized to a value between 0 and 1.

13. The system of claim 12, wherein determining that the object bounded by the first bounding box is the same object as the object bounded by the second bounding box includes determining that the similarity measure is 0.5 or greater.

14. The system of claim 8, wherein, during the training mode, parameters in the neural network are updated using a stochastic gradient descent.

15. A non-transitory computer readable storage medium storing one or more programs configured for execution by a computer, the one or more programs comprising instructions to operate in a training mode and an inference mode;
wherein in the training mode, the one or more programs comprise instructions for:
passing a dataset into the neural network, the dataset including a first training image and a second training image; and
training the neural network to accurately output a consistent output tensor for the first and second training images, wherein if the first training image includes the same entity as the second training image, a similarity module will determine via a similarity measurement that the first and second training images correspond to the same entity; and
wherein in the inference mode, the one or more programs comprise instructions for:
receiving a plurality of image frames, wherein the plurality of image frames is not part of the dataset, the plurality of image frames comprising a first image frame and a second image frame, the first image frame including a first bounding box around a first object and the second image frame including a second bounding box around a second object; and
automatically determining, using the neural network, whether the first object bounded by the first bounding box is the same object as the second object bounded by the second bounding box.

16. The non-transitory computer readable medium of claim 15, wherein the neural network comprises a convolution-nonlinearity step.

17. The method of claim 16, wherein the convolution-nonlinearity step comprises a convolution layer and a rectified linear layer.

18. The method of claim 15, wherein determining whether the first object bounded by the first bounding box is the same object as the second object bounded by the second bounding box comprises:
extracting a first plurality of pixels from the first image frame to form a first input image, the first plurality of pixels being located within coordinates of the first bounding box, the first input image being only a portion of the first image frame;
extracting a second plurality of pixels from the second image frame to form a second input image, the second plurality of pixels being located within coordinates of the second bounding box, the second input image being only a portion of the second image frame;
passing the first input image into the neural network to output a first output tensor;
passing the second input image into the neural network to output a second output tensor; and
calculating by the similarity module a similarity measure for the first and second output tensors.

19. The method of claim 18, wherein the similarity measure is normalized to a value between 0 and 1.

20. The method of claim 19, wherein determining that the object bounded by the first bounding box is the same object as the object bounded by the second bounding box includes determining that the similarity measure is 0.5 or greater.
